(19) United States
(12) Patent Application Publication
(10) Pub. No.: US 2014/0195173 A1
(43) Pub. Date: Jul. 10, 2014

(54) Method for Ascertaining Flow by Means of Ultrasound

(71) Applicants: Michal Bezdek, Aesch (CH); Pierre Ueberschlag, Saint-Louis (FR); Oliver Brumberg, Rheinfelden (DE)

(72) Inventors: Michal Bezdek, Aesch (CH); Pierre Ueberschlag, Saint-Louis (FR); Oliver Brumberg, Rheinfelden (DE)

(73) Assignee: Endress + Hauser Flowtec AG, Reinach (CH)

(21) Appl. No.: 14/235,950

(22) PCT Filed: Jul. 23, 2012
(86) PCT No.: PCT/EP2012/064370

§ 371 Date: Jan. 29, 2014

(30) Foreign Application Priority Data
Aug. 3, 2011 (DE) 10 2011 080 365.3

(51) Int. Cl. G01F 1/66

(52) U.S. Cl. CPC G01F 1/66
USPC 702/48

(57) ABSTRACT

A method for ascertaining flow of a fluid, which is a gas mixture, through a circularly cylindrical measuring tube having a straight, measuring tube, longitudinal axis and an inner diameter D_{I}, wherein at least one component of the gas mixture is a hydrocarbon. The steps comprise: ascertaining a first average flow velocity v_{L} by means of travel-time difference measurement of acoustic signals along a signal path; ascertaining a modified Reynolds number Re^{mod} according to the formula Re^{mod}=(v_{L}*D_{I})/vₖᵢₙ, wherein the kinematic viscosity vₖᵢₙ of the fluid is known; and ascertaining a second average flow velocity v_{A} by means of a known function v_{A}=f(Re^{mod}) as a function of the modified Reynolds number Re^{mod}, wherein the method step of ascertaining the modified Reynolds number Re^{mod} precedes the method step of ascertaining the kinematic viscosity vₖᵢₙ of the fluid.

The present invention relates to a method for ascertaining flow of a fluid through a circularly cylindrical measuring tube having a straight, measuring tube, longitudinal axis and an inner diameter D_{I}.

Ultrasonic, flow measuring devices are applied widely in process and automation technology. They permit easy determination of volume flow and/or mass flow in a pipeline.

Known ultrasonic, flow measuring devices frequently work according to the travel-time difference principle. In the travel-time difference principle, the different travel times of ultrasonic waves, especially ultrasonic pulses, i.e. so-called bursts, are evaluated as a function of the direction the waves travel in the flowing liquid. To this end, ultrasonic pulses are sent at a certain angle to the tube axis both with, as well as also counter to, the flow. From the travel-time difference, the flow velocity, and therewith, in the case of known diameter of the pipeline section, the volume flow, can be determined, for example, according to the formula, Q=K*((t₁−t₂)/(t₁*t₂)), wherein K is a function of the length of the signal path, the ratio between radial and axial sensor separations, the velocity distribution, respectively the flow profile in the measuring tube, and the cross sectional area, and t₁, respectively t₂, are the travel times of the signals upstream-, respectively downstream.

In the case of the Doppler principle, ultrasonic waves of a certain frequency are coupled into the liquid and the ultrasonic waves reflected by the liquid are evaluated. From the frequency shift between the coupled and reflected waves, the flow velocity of the liquid can likewise be determined. Reflections in the liquid occur, when small air bubbles or impurities are present in it, so that this principle is applied mainly in the case of contaminated liquids.

The ultrasonic waves are produced, respectively received, with the assistance of so-called ultrasonic transducers. To this end, ultrasonic transducers are placed securely in the tube wall of the relevant pipeline section. There are also clamp on, ultrasonic, flow measuring systems. In such case, the ultrasonic transducers are pressed externally on the wall of the measuring tube. A great advantage of clamp on, ultrasonic, flow measuring systems is that they do not contact the measured medium and can be placed on an already existing pipeline.

A further ultrasonic, flow measuring device working according to the travel-time difference principle is disclosed in U.S. Pat. No. 5,052,230. In such case, the travel time is ascertained by means of short ultrasonic pulses, so-called bursts.

The ultrasonic transducers are normally composed of an electromechanical transducer element, e.g. a piezoelectric element, and a coupling layer. The ultrasonic waves are produced in the electromechanical transducer element and led via the coupling layer to the pipe wall and from there into the liquid in the case of clamp-on-systems, and, in the case of inline systems, via the coupling layer into the measured medium. In such case, the coupling layer is sometimes called a membrane, or diaphragm.

Between the piezoelectric element and the coupling layer, another coupling layer can be arranged, a so called adapting, or matching, layer. The adapting, or matching, layer performs, in such case, the function of transmitting the ultrasonic signal and simultaneously reducing reflection at interfaces between two materials caused by different acoustic impedances.

Both in the case of clamp-on-systems, as well as also in the case of inline systems, the ultrasonic transducers are arranged on the measuring tube in a shared plane, either on oppositely lying sides of the measuring tube, in which case the acoustic signal, projected onto a tube cross section, passes once along a secant through the measuring tube, or on the same side of the measuring tube, in which case the acoustic signal is reflected on the oppositely lying side of the measuring tube, whereby the acoustic signal traverses the measuring tube twice along the secant projected on the cross section through the measuring tube. U.S. Pat. No. 4,103,551 and U.S. Pat. No. 4,610,167 show ultrasonic, flow measuring devices with reflections on reflection surfaces provided therefor in the measuring tube. Also known are multipath systems, which have a number of ultrasonic transducer pairs, which, in each case, form a signal path, along which the acoustic signals pass through the measuring tube. The respective signal paths and the associated ultrasonic transducers lie, in such case, in mutually parallel planes parallel to the measuring tube axis. U.S. Pat. No. 4,024,760 and U.S. Pat. No. 7,706,986 show such multipath systems by way of example. An advantage of multipath systems is that they can measure the profile of the flow of the measured medium in the measuring tube at a plurality of locations and thereby provide highly accurate, measured values for the flow. This is achieved based on, among other things, the fact that the individual travel times along the different signal paths are weighted differently. Disadvantageous in the case of multipath systems is, however, their manufacturing costs, since several ultrasonic transducers and, in given cases, a complex evaluating electronics need to be used.

There are different approaches for weighting the signal paths. The paper “Comparison of integration methods for multipath acoustic discharge measurements” by T. Tresch, T. Staubli and P. Gruber in the handout for 6th International Conference on Innovation in Hydraulic Efficiency Measurements, 30 Jul.-1 Aug. 2006 in Portland, Oreg., USA, compares established methods for weighting the travel times along different signal paths for calculating the flow

DE 10 2005 059 062 B4 and DE 10 2006 030 964 A1 disclose methods for correcting a first flow value of a gaseous fluid flowing through a measuring tube, wherein steam is a component. The concentration of the steam is determined or established by means of temperature and/or velocity of sound and then the concentrations of one or more components of the gaseous fluid are ascertained and the flow value corrected.

U.S. Pat. No. 5,835,884 A discloses determining the average flow velocity of a fluid. In such case, volume flow rate is measured in the laminar range (RN=2000) and in the turbulent range (RN=4000) and the average flow velocity for Reynolds numbers between 2000 and 4000 ascertained between the two values by a logarithmic interpolation method. An application of this method to hydrocarbon containing gas mixtures is not disclosed.

JP 56 140 214 A, U.S. Pat. No. 4,300,400, U.S. Pat. No. 5,546,813, EP 1 113 247 A1 and U.S. Pat. No. 4,331,025 A disclose methods for calculating flow velocity based on a function of Reynolds number Re and radius r. None of these documents is concerned, however, with the problem of measuring gas mixtures and the particular issues arising in such case.

The aforementioned documents are concerned exclusively with measuring flow of a fluid, however, not specially with a gas mixture, in the case of which not only the flow measurement—but, instead, also the composition is of interest and in the case of which individual, ascertained values of measured variables can be taken into consideration for determining the flow measurement and the composition for a determining of further physical variables and properties.

The present method begins, thus, with the object of providing a corresponding method, which overcomes the described problems.

An object of the invention is to provide a method for flow measurement by means of ultrasound, designed especially also for gas mixtures and delivering highly accurate measurement results.

The object is achieved by the subject matter of the independent claim 1. Further developments and embodiments of the invention are provided by the features of the respectively dependent claims.

According to the invention, a travel-time difference measurement of acoustic signals along a signal path is performed in a circularly cylindrical measuring tube having a straight, measuring tube, longitudinal axis and an inner diameter D_{I}. This is accomplished preferably with a suitable ultrasonic, flow measuring device. The travel-time difference measurement of acoustic signals along a signal path between two ultrasonic transducers in the upstream- and downstream directions is known to those skilled in the art.

Serving both as transmitter as well as also receiver are usually ultrasonic transducers, especially electromechanical transducers, e.g. piezoelectric elements, which are suitable to send as well as also to receive the acoustic signal, especially an ultrasonic pulse or one or more ultrasonic waves. If ultrasonic transducers are applied as transmitters and receivers, the acoustic signal can pass along the first signal path back and forth, thus in two directions. Transmitter and receiver are, thus, exchangeable.

Referred to as the signal path, also called an acoustic path, is the path of the acoustic signal, thus e.g. the ultrasonic wave or the ultrasonic pulse, between the transmitter, which transmits the acoustic signal, and the receiver, which receives the acoustic signal. In an embodiment of the invention, the acoustic signal is, such as usual in the case of an inline system, radiated perpendicularly to the membrane. The receiver is then so emplaced in or on the measuring tube that the signal, in turn, strikes perpendicularly on its membrane.

If the signal path is composed of a plurality of straight subsections, thus, if, for example, the acoustic signal is reflected on one or more reflection surfaces, which are interfaces formed e.g. between fluid and measuring tube or a reflector arranged on or in the measuring tube, all straight subsections have the same separation from the measuring tube axis, especially the signal path and therewith all of its subsections j extend in a plane parallel to the measuring tube axis, which separation dⱼ is especially unequal to about a fourth of the inner diameter D_{I} (dⱼ≠D_{I}/4). In a further development of the invention, the signal path lies in a plane, in which the measuring tube axis lies. Projected on a cross section of the measuring tube, the inner diameter D_{I} results, since the separation of all subsections of the signal path from the measuring tube, longitudinal axis is zero. The result of the travel-time difference measurement is an average flow velocity v_{L}.

A further method step in an embodiment of the method of the invention is the ascertaining of the kinematic viscosity vₖᵢₙ of the fluid. The kinematic viscosity νₖᵢₙ is related to the dynamic viscosity μ_{dyn} in the following way: νₖᵢₙ=μ_{dyn}/ρ. Thus, if the dynamic viscosity μ_{dyn} is ascertained and the density ρ is known or itself ascertained, then the kinematic viscosity μₖᵢₙ is at hand.

There are many variants, by which the kinematic viscosity νₖᵢₙ of the gas mixture can be ascertained. Examples include using a table, a mathematical formula or linear interpolation between known values. The kinematic viscosity νₖᵢₙ of the fluid can, in such case, depend on different variables and can be correspondingly ascertained.

If the chemical composition of the gas mixture is known in terms of the individual material quantity fractions xᵢ of its components i in the case of a multicomponent system, for example, via input provided by the user or by, in given cases also separately, ascertaining such, the kinematic viscosity vₖᵢₙ of the fluid is ascertained, for example, via the supplemental input of the temperature T of the fluid. In this regard, a temperature sensor can be provided.

Taking into consideration the material fractional amount xᵢ of the individual components i of the gas mixture, it is to be understood that at least the velocity of sound and the temperature are predetermined or measured, since these variables enable calculation of the material fractional amounts. Thus, the material quantity fraction can be included directly in the calculation of the dynamic viscosity and therewith be taken into consideration.

Since the material quantity fraction can be calculated via the velocity of sound and the temperature of the medium, thus, by taking into consideration the temperature and the velocity of sound in the calculation, the kinematic viscosity of the material quantity fraction can be indirectly taken into consideration.

However, in the case of gas mixtures, especially in the case of biogases, the composition of the gas mixture can vary. In such case, the variable kinematic viscosity can be determined by a so-called, real time measurement. This means that, supplementally to flow, at least one changeable variable is measured repeatedly at a time interval. This is preferably the velocity of sound in the gas mixture, from which, then, in the case of constant temperature and constant pressure, an inference of a change in the material quantity fractions of the gas mixture and/or directly of the kinematic viscosity can be made. A preferred repetition interval lies between 5-500 msec (milliseconds), especially preferably, however, between 10-250 msec.

It is advantageous, when the kinematic viscosity νₖᵢₙ of the gas mixture is ascertained by measuring the temperature of the gas mixture and the velocity of sound c in the gas mixture, as well as from certain variables required for determining material-specific properties.

The dynamic viscosity of the gas mixture results advantageously by specifying and/or measuring
the relative humidity of the gas mixture and
the pressure of the gas mixture and/or the density of the gas mixture
in combination with the ascertained kinematic viscosity νₖᵢₙ of the gas mixture.

Exactly in the case of gas mixtures with time variable composition, for example, biogas, the temperature of the gas mixture often changes overall. These changes must be taken into consideration in determining the kinematic viscosity. In such case, a one-time measurement can be insufficient for these variables and a measurement repetition at a time interval can be advantageous. The measuring interval for temperature measurement lies, in such case, preferably at a maximum of 5 min, especially between 5 sec and 2 min.

Additionally, also an optional measuring of the pressure and the relative humidity can be repeated at the aforementioned time intervals.

In order to enable an exact measuring with small error, it is advantageous, when the hydrocarbon has a material quantity fraction xᵢ of at least 0.1 with reference to the total mass of the gas mixture.

Alternatively, the kinematic viscosity νₖᵢₙ of the fluid is ascertained as a function of the velocity of sound c in the fluid, the temperature T of the fluid, the absolute pressure p of the fluid and the chemical composition of the fluid. Velocity of sound c in the fluid and temperature T of the fluid can, in such case, be ascertained in known manner by the ultrasonic, flow measuring device, or they can be separately ascertained. In the same way, also the density ρ of the fluid is ascertainable.

These are only some examples without any claim of completeness. It is not intended that other methods of ascertaining the kinematic viscosity νₖᵢₙ of the fluid should therewith be excluded.

Thus, other method steps can precede the method step of ascertaining the modified Reynolds number Re^{mod}. Examples include ascertaining the chemical composition of the fluid and/or ascertaining the material quantity fractions xᵢ of the individual components i of the fluid, wherein these can also be predetermined by the user, and/or ascertaining the velocity of sound c in the fluid and/or ascertaining the temperature T of the fluid and/or ascertaining the absolute pressure p in the fluid, wherein then the kinematic viscosity νₖᵢₙ of the fluid is ascertained in suitable manner as a function of one or more of these parameters. In the case of gaseous fluids, ascertaining the absolute pressure p plays a greater role than in the case of liquid fluids, since most of these can be considered, for practical purposes, as incompressible.

If, according to a further development of the invention, the fluid is a gas, especially a biogas, with the components methane, water and carbon dioxide, which biogas also can have other components, such as e.g. nitrogen, oxygen, hydrogen, hydrogen sulfide and/or ammonia, then DE 10 2006 030 964 A1 teaches assuming the relative humidity of the fluid to be 100% or supplementally to provide a humidity measuring unit, in order to ascertain the concentration of water as a function of temperature T and the relative humidity RH and to take such into consideration in determining the concentrations of methane and carbon dioxide. This should likewise be included here.

In the next method step, a modified Reynolds number Re^{mod} is ascertained according to the formula Re^{mod}=(v_{L}*D_{I})/νₖᵢₙ, wherein then a second flow velocity v_{A} averaged over the cross sectional area of the measuring tube is ascertained by means of a known function v_{A}=f(Re^{mod}) as a function of the modified Reynolds number Re^{mod} and, according to a further development of the invention, output by the device. In such case, the function v_{A}=f(Re^{mod}) in the sense the present invention does not express a formula in the mathematical sense, but, instead, a proportionality between v_{A} and f(Re^{mod}).

Taking into consideration the first average flow velocity v_{L}, the formula for calculating the second average flow velocity v_{A} becomes: V_{A}=f(Re^{mod})*V_{L}

In a variant of the invention, the volume flow Q_{V}=v_{A}*(π/4)*D_{I}² and/or the mass flow Q_{M}=Q_{V}*ρ with the density ρ of the fluid are/is calculated and then output by the device.

For ascertaining the function v_{A}=f(Re^{mod}), there exist, analogously to the ascertaining of the kinematic viscosity νₖᵢₙ, likewise many options. One of these is to investigate the ratio v_{L}/v_{A} as a function of Reynolds number Re, respectively modified Reynolds number Re^{mod}, e.g. in a suitable calibration plant, experimentally in greater detail and to keep such in the form of a function f. In the case of constant Reynolds number, v_{L} is proportional to v_{A}: v_{A}=f(Re^{mod})*v_{L}. The relationship v_{A}/v_{L}, versus Re^{mod} is generally true for all fluids. Therefore, it is not absolutely necessary to use in the calibration plant the same fluid as in the field.

Applied for performing the method is an ultrasonic, flow measuring device having a circularly cylindrical measuring tube having a straight, measuring tube, longitudinal axis and an inner diameter D_{I}, two ultrasonic transducers for travel-time difference measurement of an acoustic signal along a signal path in the measuring tube and a suitable transmitter unit for evaluating the travel-time difference measurement and for performing the method of the invention, especially a so called inline, ultrasonic, flow measuring device having a measuring- or signal path, which is arranged centrally.

The invention is amenable to numerous forms of embodiment. One thereof will now be explained in greater detail based on the appended drawing, the figures of which show as follows:

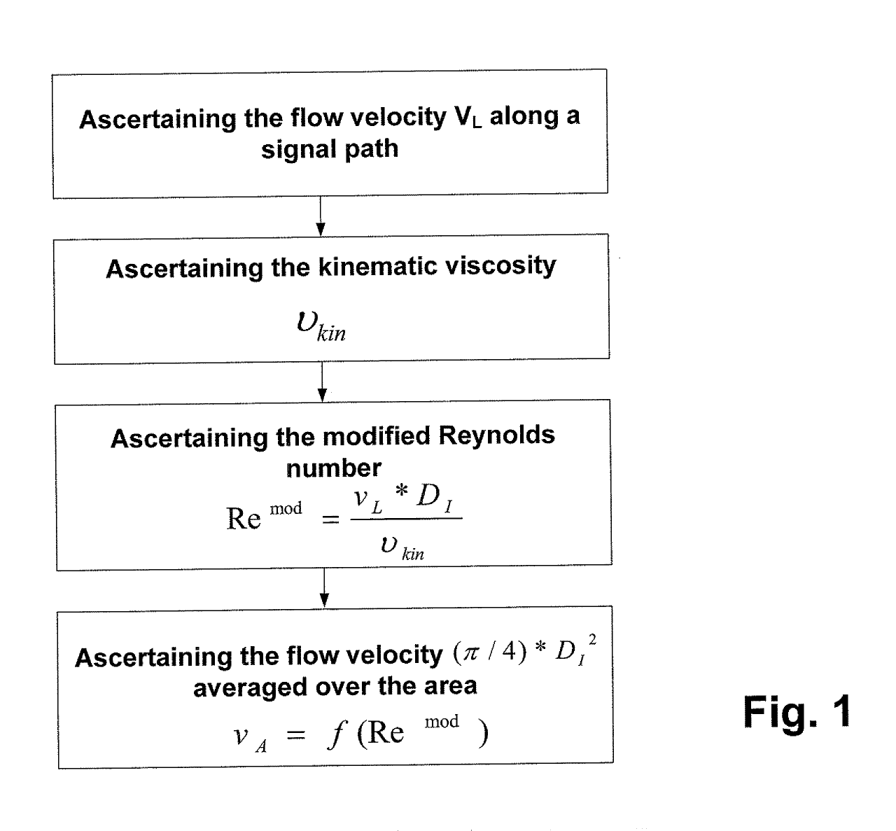

FIG. 1 a flow diagram of an embodiment of the method of the invention,

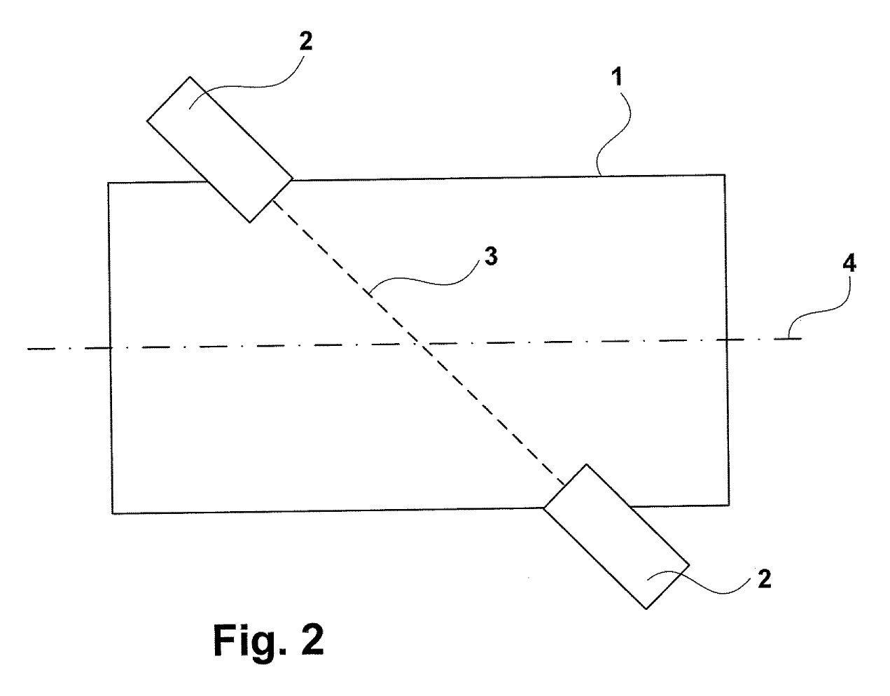

FIG. 2 schematically, an inline, ultrasonic, flow measuring device.

FIG. 1 shows a flow diagram of an embodiment of the method of the invention. Starting point is, as in the case of DE 10 2006 030 964 A1, the flow measurement of a biogas of the above said components flowing through a measuring tube.

The steam fraction is estimated or measured with a humidity measuring unit.

Then, via the measured velocity of sound c and the measured temperature T and, in given cases, the measured pressure p, the dynamic, or also the kinematic, viscosity of the biogas can be ascertained via corresponding algorithms. The formula Re^{mod}=(v_{L}*D_{I})/νₖᵢₙ yields the modified Reynolds number.

From a known relationship v_{A}/v_{L} versus Re, then the flow velocity v_{A} output by the flow measuring device can be corrected as a function of the Reynolds number.

The Reynolds number is obtained via the formula, Re=(v_{A}*D_{I})/νₖᵢₙ, wherein v_{A} is the flow velocity of the fluid through the measuring tube averaged over the total measuring tube cross section. v_{A} is, thus, the surface integral. v_{L} is, in contrast, the average flow velocity measured along the signal path and, correspondingly, the line integral along the signal path.

FIG. 2 illustrates, schematically, the construction, well known to those skilled in the art, of a single path-inline, ultrasonic, flow measuring device having two ultrasonic transducers 2 arranged fluid contactingly in the measuring tube 1. The signal path 3 between the ultrasonic transducers 2 has a predetermined inclination relative to the measuring tube axis 4, which enables a travel-time difference measurement.

In the following based on an example of an algorithm, ascertaining of the dynamic viscosity will now be presented.

$$η = ( 0.0003229 * {T}^{3} - 0.0071429 * {T}^{2} - 0.1327381 * T - 180.014 ) * {10}^{- 6} * {X}_{CH 4}^{2} + ( 0.030833 * {T}^{3} - 2.43678 * {T}^{2} - 48.39 * T - 15616.83 ) * {10}^{- 6} {X}_{CH 4} + ( - 7.8125 * {T}^{3} + 432.1428 * {T}^{2} + 38303.6 * T + 13704714 ) * {10}^{- 6}$$

Based on this algorithm, one can recognize that the dynamic viscosity is calculable based on the temperature of the biogas and on the material fractional amount of methane in the biogas. In such case, the material quantity fraction is expressed as a molar fraction, respectively volume fraction, in % and temperature in ° C. lies in a range between 0-80° C., wherein the viscosity can be calculated with an accuracy of 0.5%—preferably 0.2%—at 1 bar, to the extent that no foreign gas influence is present.

The density in kg/m³ can be calculated via the following formula

$$ρ = \frac{p}{K \cdot T}$$

with the predetermined or ascertained pressure being expressed in mbar and the measured temperature in degrees Kelvin.

In such case, K is calculated as follows:

$$K = \frac{1}{\frac{{X}_{CO2 }}{1.885} + \frac{{X}_{CH 4}}{5.18} + \frac{{X}_{H 20}}{4.61} + \frac{{X}_{N 2}}{2.97} + \frac{{X}_{O 2}}{2.6}}$$

wherein X is scaled between 0-1.

The kinematic viscosity can then be ascertained from the relationship: ν=η/ρ.

The Reynolds number Re exhibits the following dependence:

Re=V.D/ν or Re=ρ.V.D/η

### List of Reference Characters

1 measuring tube
2 ultrasonic transducer
3 signal path
4 measuring tube axis

1-15. (canceled)

16. A method for ascertaining flow of a gas mixture through a circularly cylindrical measuring tube having a straight, measuring tube, longitudinal axis and an inner diameter D_{I}, wherein at least one component i of the gas mixture is a hydrocarbon, comprising the steps of:
ascertaining a first average flow velocity v_{L} by means of travel-time difference measurement of acoustic signals along a signal path;
ascertaining a modified Reynolds number Re^{mod} according to the formula Re^{mod}=(v_{L}*D_{I})/vₖᵢₙ, wherein the kinematic viscosity vₖᵢₙ of the gas mixture is known; and
ascertaining a second average flow velocity v_{A} by means of a known function v_{A}=f(Re^{mod}) as a function of the modified Reynolds number Re^{mod}, wherein the method step of ascertaining the modified Reynolds number Re^{mod} precedes the method step of ascertaining the kinematic viscosity vₖᵢₙ of the gas mixture; and
ascertaining the kinematic viscosity vₖᵢₙ of the gas mixture occurs taking into consideration the material fractional amounts xᵢ of the individual components i of the gas mixture.

17. The method as claimed in claim 16, wherein:
determining of velocity of sound is repeated at a time interval for determining the material fractional amounts xᵢ of the individual components i of the gas mixture or the kinematic viscosity vₖᵢₙ.

18. The method as claimed in claim 16, wherein:
the kinematic viscosity vₖᵢₙ of the gas mixture is ascertained by measuring the temperature of the gas mixture and the velocity of sound c in the gas mixture, as well as from predetermined variables required for determining material-specific properties.

19. The method as claimed in claim 16, wherein:
the dynamic viscosity of the gas mixture is ascertained by specifying and/or measuring the relative humidity of the gas mixture and the pressure of the gas mixture and/or the density of the gas mixture in combination with the ascertained kinematic viscosity vₖᵢₙ of the gas mixture.

20. The method as claimed in claim 16, wherein:
the hydrocarbon has a material quantity fraction xᵢ of at least 10%, with reference to the total volume of the gas mixture.

21. The method as claimed in claim 16, further comprising the step of:
ascertaining the volume flow Qᵥ=v_{A}*(π/4)*D_{I}², and/or the mass flow Q_{M}=Q_{V}*ρ, with the density ρ of the gas mixture.

22. The method as claimed in claim 16, further comprising the step of:
outputting the second average flow velocity v_{A} and/or the volume flow Q_{V} and/or the mass flow Q_{M}.

23. The method as claimed in claim 16, wherein:
the signal path is composed of one or more straight subsections, each of which has the same separation from the measuring tube longitudinal axis.

24. The method as claimed in claim 22, wherein:
the separation of the subsections of the signal path from the measuring tube longitudinal axis is zero.

25. The method as claimed in claim 16, further comprising the step of:
ascertaining the kinematic viscosity vₖᵢₙ of the gas mixture occurs taking into consideration the chemical composition of the gas mixture.

26. The method as claimed in claim 25, wherein:
the material quantity fraction xᵢ of the individual component i of the gas mixture is the methane fraction of the gas mixture

27. The method as claimed in claim 24, wherein:
the chemical composition of the gas mixture and/or the material quantity fractions xᵢ of its individual components i are predetermined by the user.

28. The method as claimed in claim 23, further comprising the step of:
ascertaining the kinematic viscosity vₖᵢₙ of the gas mixture occurs taking into consideration the temperature T of the gas mixture and/or the velocity of sound c in the gas mixture.

29. The method as claimed in claim 16, wherein:
the gas mixture is a biogas comprising the components methane, water and carbon dioxide.

30. The method as claimed in claim 16, wherein:
an ascertaining, preferably a one-time ascertaining, of the functional specification f(Re^{mod}) occurs;
a periodic determining of the first average flow velocity v_{L} occurs; and
a calculating of the second average flow velocity is performed based on the formula v_{A}=f(Re^{mod})*v_{L}.
